(19) United States
(12) Patent Application Publication
(10) Pub. No.: US 2022/0366615 A1
(43) Pub. Date: Nov. 17, 2022

(54) SEE-THROUGH DISPLAY, METHOD FOR OPERATING A SEE-THROUGH DISPLAY AND COMPUTER PROGRAM

(71) Applicant: Telefonaktiebolaget LM Ericsson (publ), Stockholm (SE)

(72) Inventors: Mitra DAMGHANIAN, Upplands-Bro (SE); Martin PETTERSSON, Vallentuna (SE); Rickard SJÖBERG, Stockholm (SE)

(21) Appl. No.: 17/774,165

(22) PCT Filed: Nov. 4, 2019
(86) PCT No.: PCT/EP2019/080106

§ 371 Date: May 4, 2022

(51) Int. Cl. G06T 11/00; H04N 9/31; G06T 7/70; G06T 3/40; G02B 27/01

(52) U.S. Cl. CPC G06T 11/00; H04N 9/3179; G06T 7/70; G06T 3/40; G02B 27/0172; G02B 2027/014; G02B 2027/0138; G02B 2027/0118

(57) ABSTRACT

There is provided a see-through display and a method for operating a see-through display. The display is configurable to display additional image content for augmenting a user's view of a scene visible through the display. According to the method, image data are received defining an image of a scene visible through the display. By analysis of the received image data, one or more characteristics of the scene are determined. A light effect to be applied to the user's view of the scene is determined. Additional image content is generated according to the determined light effect and according to the one or more determined characteristics of the scene. The generated additional image content is displayed to the user such that light received from the scene is combined with the additional image content, thereby to implement the determined light effect in the user's view of the scene.

### TECHNICAL FIELD

The proposed technology relates generally to displays, in particular to transparent (“see-through”) head-mounted or head-up displays. In particular, but not exclusively, the proposed technology relates to a method of operating a see-through display, to a computer program and to a computer program product.

### BACKGROUND

Augmented reality (AR) and mixed reality (MR) are terms used to describe a user's visual experience of a real-world scene where, for example, computer-generated text, symbols or other 2-dimensional (2D) or 3-dimensional (3D) image content may be superimposed on a user's view of the scene, providing a composite view. In known AR/MR solutions, the aim is usually to superimpose additional image content in the user's view of a scene. One great advantage of AR over virtual reality (VR) is that AR does not obstruct reality, in that the scene remains generally visible.

Known AR/MR solutions may display additional image content at one or more fixed positions within the image area of a display so that the image content appears to move with the display, relative to the scene, as orientation of the display changes. Alternatively, the additional image content may be continuously re-positioned within the image area of the display to appear fixed in space relative to features visible in the scene as the orientation of the display changes. Information defining changes in orientation of a display may be used to determine where in the display to position the additional image content so that it appears anchored to features visible within a scene, and to appear to remain in fixed position relative to those features as orientation of the display changes. In a typical digital display generating image content using a frame-based image generator, the position of additional image content within the image area of the display may be recalculated for every frame to ensure that it tracks the changing orientation of the display.

The positions of features visible within the image area of a display may for example be determined and mapped using algorithms such as simultaneous localization and mapping (SLAM). A SLAM algorithm analyses images captured by a camera attached or at a known location relative to the display device, generates a map of features identifiable within the scene and thereby tracks movement of the camera by analysis of subsequent captured images. Alternatively, changes in position and/or orientation of a display device may be determined using data output by movement sensors attached to the display device or using another type of display device tracker system.

Some AR/MR systems provide interactive augmentations and may include audio and video to augment a user's view of a real-world scene.

Augmented/mixed reality display devices may for example include handheld devices such as mobile phones and other types of portable computing device having opaque displays, or transparent, see-through display devices, including head up displays (such as those projecting onto a windshield or other transparent combiner) and head-mounted devices, for example displays incorporated into spectacles or helmet displays.

See-through displays may for example introduce computer-generated image content into a user's view of a scene by projection onto a transparent combiner or by projection directly onto the retina of the user's eye. Alternatively, an optical waveguide may be used as a transparent combiner to combine a 2-dimensional (2D) or 3-dimensional (3D) computer-generated image, conveyed through the waveguide and output along a user's line of sight, with a user's view of the scene. Such images may for example comprise still or moving video images, light-field images and holographically-generated images.

### SUMMARY

According to a first aspect disclosed herein, there is provided a method for operating a see-through display, the display being configurable to display additional image content for augmenting a user's view of a scene visible through the display. The method begins with receiving image data defining an image of a scene visible through the display and, by analysis of the received image data, determining one or more characteristics of the scene. A light effect to be applied to the user's view of the scene is then determined. For the determined light effect, and according to the one or more determined characteristics of the scene, additional image content is generated. The additional image content is displayed to the user such that light received from the scene is combined with the additional image content, thereby to implement the determined light effect in the user's view of the scene.

In existing AR/MR solutions applied to see-through displays, the aim is usually to overlay text, objects or other image artefacts in a user's view of a scene without otherwise altering the user's view of the scene. Existing AR/MR solutions are not therefore able to apply a particularly required light effect to a user's view of the scene. More particularly, existing AR/MR solutions are not able to adjust the particularly required light effect according to determined characteristics of the scene, for example according to the determined presence of objects, luminance or colour profiles or other features in the scene. Such benefits are however available using embodiments of the present invention disclosed herein.

According to example embodiments disclosed herein, a user's perception of light passing through a see-through display from a real-world scene may be altered in one or more ways to create visible changes to the user's perception of light received from the real-world scene. For example, the way in which objects viewable in the scene appear to be illuminated may be altered. This differs from AR/MR applications in which an opaque display screen is used to display digitally encoded images of a scene that have been captured by a camera and manipulated, before display on the screen. In the present invention, a user's perception of light from the real-world scene is being altered so that the user sees different light effects when viewing the scene through the display as compared with viewing the scene without the display, while continuing to view light from the scene.

One benefit of embodiments of the present invention is that the user continues to view light from a real-world scene at the user's normal viewing resolution. The user's viewing experience can be enhanced without obstructing the natural viewing of the real-world scene. AR/MR applications using opaque displays, for example the opaque screens of mobile phones, tablet displays, or “immersive” VR head-mounted displays, often provide an inferior digital reproduction of a real-world scene, the user having no direct view of light from the real-world scene.

According to a second aspect disclosed herein, there is provided a see-through display. The see-through display has an image generator configured to generate additional image content and to project the generated additional image content along a user's line of sight to a scene visible through the display. In this way, light received from the scene is combined with the additional image content in the user's view of the scene. The display also comprises a processor, linked to the image generator. The processor is configured to receive image data representing an image of a scene visible through the display. The processor is configured to determine, by analysis of the received image data, one or more characteristics of the scene. The processor is configured to determine a light effect to be applied to the user's view of the scene. The processor is configured to control the image generator to generate and to project additional image content according to the determined light effect and according to the one or more determined characteristics of the scene. In this way, the user perceives the determined light effect when viewing the scene through the display.

According to a third aspect disclosed herein, there is provided a computer program. When the computer program is loaded into and executed by a processor of a see-through display, the program causes the processor to receive image data representing an image of a scene visible through the display. The program also causes the processor to determine, by analysis of the received image data, one or more characteristics of the scene. The program also causes the processor to determine a light effect to be applied to a user's view of the scene through the display. The program also causes the processor to control an image generator of the display to generate and to project additional image content according to the determined light effect and according to the one or more determined characteristics of the scene.

### BRIEF DESCRIPTION OF DRAWINGS

Example embodiments of the proposed technology will now be described in more detail and with reference to the accompanying drawings of which:

FIG. 1 shows, in a schematic representation, examples of known see-through displays;

FIG. 2 shows, in a schematic representation, see-through displays according to example embodiments of the present invention;

FIG. 3 shows, in a flow diagram, a process as may be implemented in respect of a see-through display according to example embodiments of the present invention; and

FIG. 4 shows, in a schematic representation, example arrangements of components in a see-through display shown in FIG. 2, according to example embodiments of the present invention.

### DETAILED DESCRIPTION

Known augmented reality (AR) and mixed reality (MR) display arrangements provide a user with a view of a scene, for example a real-world scene, and augment that view with additional image content. The user's view of the scene may comprise live images being displayed on an opaque screen of a real-world scene captured by a camera. The scene may alternatively be a combination of an image of a real-world scene captured by a camera and AR/MR image content. If using a see-through display, the user may continue to view light from a real-world scene directly through the see-through display.

If using an opaque screen and a camera, for example a mobile phone or other portable computing device, additional image content may be combined digitally to augment a digitally encoded image of a real-world scene captured by the camera. The resultant digitally combined image may then be displayed on the opaque screen.

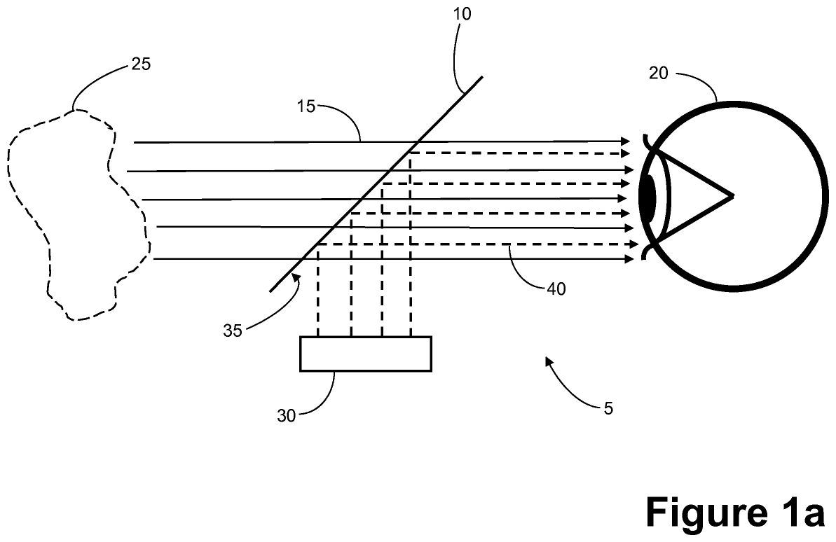

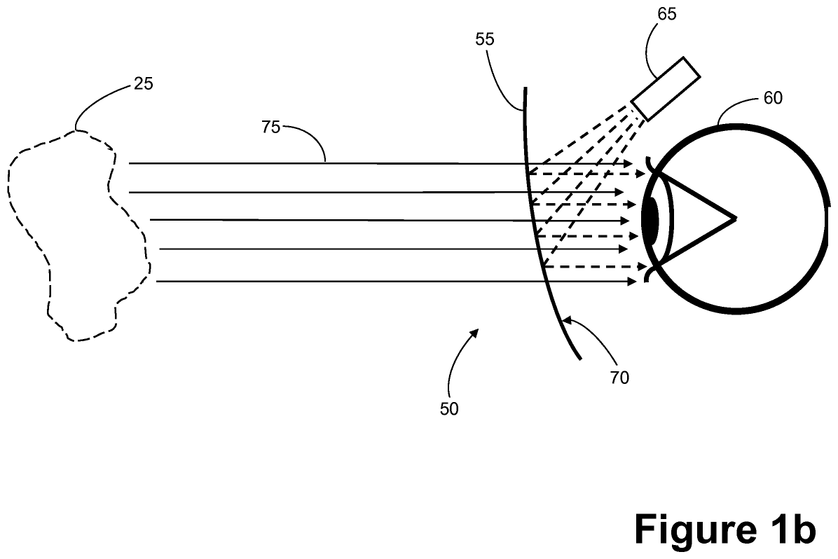

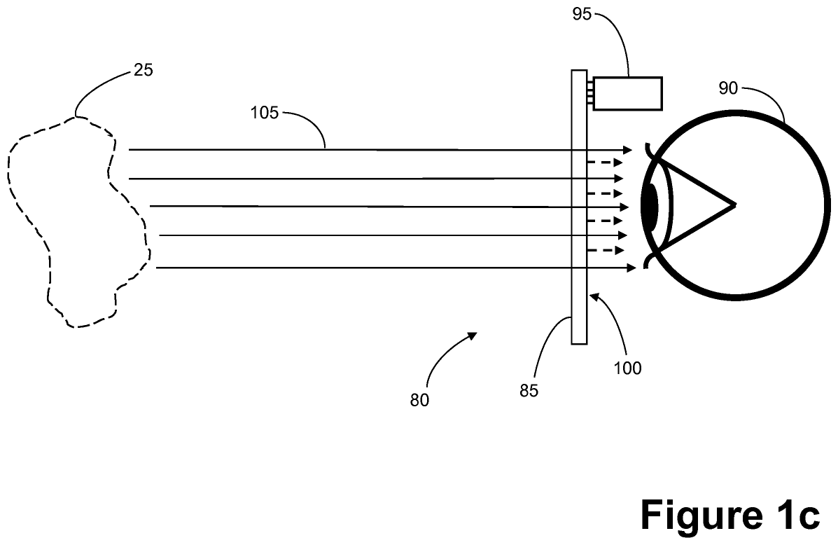

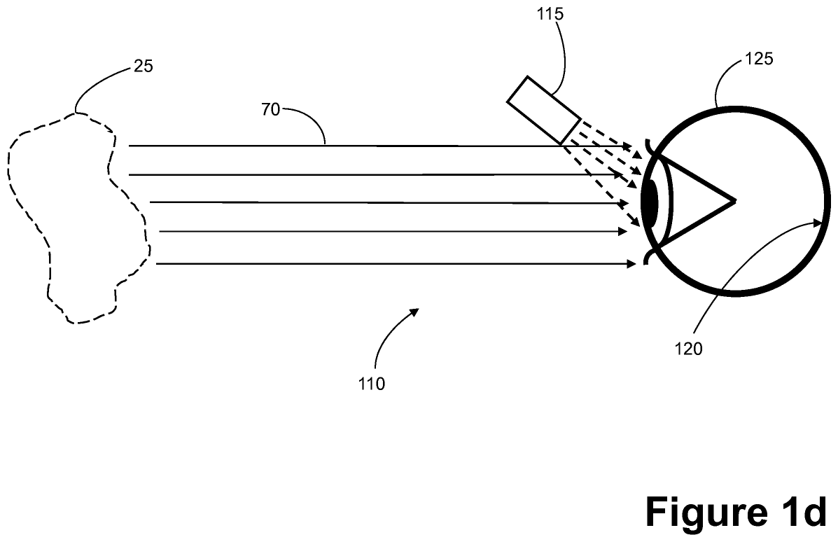

If using a see-through display, the additional image content is projected so that it may be viewed along a user's direct line of sight to the real-world scene, so appearing to overlay the user's view of the real-world scene. Examples of known types of see-through display include: a head-up display system as shown schematically in FIG. 1a; and a head-mounted display system as shown schematically in FIG. 1b, 1c and 1d. The head-mounted display system may comprise any of a range of head-mounted structures designed to support components of the display. The additional image content displayed in these known see-through displays may for example comprise any combination of text, symbols, objects, characters or other still or moving video content which may be displayed overlaying a user's view of the real-world scene.

Referring to FIG. 1a, in a head-up display system 5, a transparent combiner 10 is oriented at substantially 45° to a line of sight 15 through the combiner 10 from an eye 20 of a user to a real-world scene 25. The additional image content may be projected by an image generator and optical projector arrangement 30 onto a user-facing surface 35 of the combiner 10. The projected image content is then at least partially reflected by the combiner 10 along a line 40, coincident with the line of sight 15 of the user. In this way the additional image content appears to the user to overlay their view of the real-world scene 25. In particular, if the projected light is collimated so that the image content appears to the user to be focussed at infinity, the user's focus on the additional image content appears more accurately to match the user's focus on the real-world scene 25.

Referring to FIG. 1b, in a head-mounted display 50, a transparent combiner 55 is suspended in front of the eye 60 of a user so that the user may view the real-world scene 25 through the combiner 55. The combiner 55 may be a curved transparent combiner as shown in FIG. 1b, for example a visor of a helmet, or the lens or lenses of a type of spectacles or goggles worn by the user. An image projector 65 mounted in a fixed position with respect to the combiner 55 may project image content onto a user-facing surface 70 of the combiner 55. The projected image content is at least partially reflected by the combiner 55 towards the user's eye 60 along a line of sight 75 from the user's eye 60 to the real-world scene 25.

Referring to FIG. 1c, in an alternative head-mounted display arrangement 80, a transparent waveguide 85 is supported in front of an eye 90 of a user. The user is able to view the real-world scene 25 through the transparent waveguide 85. An image generator/projector 95 injects collimated light carrying additional image content into the waveguide 85. The waveguide 85 conveys the injected light by total internal reflection and outputs the injected light, for example using a diffraction grating, from a user-facing surface 100 of the waveguide 85 along a line of sight 105 to the real-world scene 25 from the eye 90 of the user.

Referring to FIG. 1d, in an alternative head-mounted display arrangement 110, a head-mounted image projector 115 is positioned to project additional image content directly towards the retina 120 of a user's eye 125 such that the additional image content appears to overlay the user's view of the real-world scene 25. In such an arrangement, the retina 120 acts as a combiner in the display system 110.

A head-mounted display may comprise any selection or combination of one or more of the arrangements shown in FIGS. 1b, 1c and 1d.

In each of the see-through display arrangements shown in FIG. 1, the user retains a direct view of light from the real-world scene. This is in contrast to display systems involving an opaque screen that rely upon a camera to capture images of the real-world scene for display to the user.

It is known in opaque display systems to analyse a digital video image captured by a camera, to alter the digital image to introduce additional image content, and to display the altered image on an opaque screen. The additional image content may include effects of applying different lighting to a scene captured by the camera. For example, changes may be made to the luminance of pixels captured by the camera to simulate changes in the illumination of objects in the scene. Those changes may include altering areas of a light and shade within the captured image so as to simulate a new light source appearing to illuminate particular objects within the scene. It is known to apply these techniques to video frames captured by a camera attached to the display, e.g. a mobile phone or portable tablet computer, and to display the altered images on a screen to simulate a view of a scene including one or more objects lit by a simulated light source.

The additional image content may be displayed at one or more fixed positions in the image area of a display. Alternatively, the additional image content may be displayed so as to appear to the user to be fixed relative to an object or feature in a scene being viewed, irrespective of changes in orientation of the display, i.e. the additional image content is “space-stabilised”. To be able to display space-stabilised image content, the position in the image area of the display at which the additional image content is to be displayed needs to be recalculated for each newly displayed image frame as the orientation of the display changes, so as to track the changing direction from which the scene is being viewed. If the direction of viewing the object or feature in the scene passes beyond the aperture of the display, the position of the associated additional image content also moves beyond the aperture of the display and is no longer displayed.

For example, the position of features within a scene, and changes in orientation of the display relative to the scene, may be tracked using algorithms such as SLAM, referenced above. Changes in orientation of the display itself may alternatively, or in addition, be tracked using movement sensor data output by movement sensors attached to the display, or by another type of display tracking system. A determined orientation of the display may be used as an approximate indication of a line of sight of a user through the display to a real-world scene, in particular where the display is a head-mounted display. Movement sensors may include inertial sensors of various known types, or components of a tracking system comprising components mounted on the display and components mounted separately to the display at known locations.

Examples of the latter include optical tracking systems, magnetic tracking systems and radio-frequency (RF)-based position determining systems.

Besides tracking changes in orientation of the display, it may be beneficial also to determine a direction of gaze or line of sight of a user's eye through the display. It is known to integrate an eye-tracking mechanism in AR/MR displays to detect the line of sight of an eye and to signal changes in that line of sight. The determined line of sight may be used in various ways, for example to enhance or to alter displayed image content according to the determined line of sight of the user. For example, recognising that the sensitivity of an eye to particular measures of image quality may reduce with increased viewing angles beyond the line of sight of the eye, the image quality of additional image content may be reduced for those regions known to be peripheral to the user's line of sight.

In existing AR/MR solutions using see-through displays, the aim is usually to superimpose additional image content such as symbols, text, objects or characters in the user's view of a scene without otherwise affecting the user's view of the scene.

According to example embodiments disclosed herein, the user of a see-through display is able to apply personalised adjustments to their view of the scene through the display. For example, the display may be configured to alter scene properties perceived by the user.

Alterations to scene properties may for example include, without limitation, alterations to scene lighting, style (as in style transfer), mood or ambiance. Such alterations may be made for the benefit of a viewer in a single or multi-viewer arrangement thereby to enhance the viewing experience of the scene. In this invention, the scene may comprise a real-world scene or a combination of a real-world scene and any overlaid AR image content. Example embodiments to be described below may be implemented or used either individually or as a combination or features in a see-through display system.

According to example embodiments disclosed herein, light passing through a see-through display from a real-world scene may be altered in various ways to create visible changes to that light as compared to the light if viewed without the display. While the user continues to view light from the real-world scene directly, light received from one or more selected regions of the scene may be altered, for example in perceived luminance or colour, before reaching the user's eye. The user then perceives those one or more regions of the scene differently. In particular, light received from one or more particular objects or features identifiable within the scene may be altered such that the object or feature appears to be differently illuminated, for example by a differently positioned light source, or a light source having a different colour of light. This differs from the situation in an opaque display screen where images captured by a camera are manipulated digitally and displayed on the screen to simulate different light effects. In the present invention, the user's perception of light received from the real-world scene is altered to create the different light effects so that a user continues to view at least some of the light from the real-world scene at the user's normal viewing resolution.

Advantageously, as compared with AR/MR applications of opaque displays, embodiments of the present invention may provide an altered view of a real-world scene with higher image quality, e.g. higher image resolution, higher colour accuracy, reduced or absence of latency. Furthermore, in embodiments of the present invention, the altered view may be provided without breaking the line of sight of the user or altering the scaling of the real-world scene. The known technique of digital processing and display of a camera image of the real-world scene by opaque displays of mobile phones, other portable computing devices or “immersive” VR head-mounted displays, provides no direct view to the user of light from the real-world scene. Such techniques may also involve some level of compromise on image resolution, colour accuracy, latency, viewing experience, etc. Such compromises may be reduced or avoided in the see-through displays of the present invention.

According to example embodiments disclosed herein, alterations to the light received from particular regions of a scene, e.g. from particular objects or features, are made in such a way as to track changes in the orientation of the display and corresponding changes to the user's line of sight to those objects or features through the display. In this way, the perceived alterations remain fixed relative to the line of sight of the user through the display as the orientation of the display changes. For example, if simulating the illumination of an object in the real-world scene, visible through the display, by a virtual light source, the object will continue to appear to be illuminated by that light source if the orientation of the display changes, so long as the object remains visible to the user through the display. That is, the virtual illumination effect is “space-stabilised” within the display to the user's view of the object.

According to example embodiments disclosed herein, alterations to the light received from the scene may comprise one or both of additive and subtractive alteration. For example, perceived alterations to a region in a user's view of a scene may be achieved by filtering, blocking or partially blocking light from the region to alter the perceived luminance of that region. Alternatively, or in addition, perceived alterations to a region in the scene may be achieved by filtering, blocking or partially blocking light in one or more frequency ranges. Alternatively, or in addition, perceived alterations to a region in the scene may be achieved by passing light within only one or more defined ranges of wavelengths from the region in the scene, or from the whole scene, to cause a change in perceived colour. Alternatively, or in addition, the user's perception of a region of a scene may be altered by generating additional image content corresponding to the region in the scene and displaying it to the user in combination with light received from the region of the scene, whether altered by an optical filter or not. The additional image content may be space-stabilised within the display to track changes in the user's direction of viewing the scene through the display.

In one example embodiment, light from a whole scene may be altered subtractively by an optical filter or other optical device configured to reduce its luminance or to pass only selected wavelengths of light. Additional image content may be generated to augment light passed by the optical filter. For example, the additional image content may relate only to one or more selected regions of the scene thereby to alter the perceived luminance or colour of those selected one or more regions.

In another example embodiment, light from one or more selected regions in the scene may be altered subtractively by an optical filter or other optical device to reduce the luminance of the light from the region or to pass only selected wavelengths of the light. At the same time, additional image content may be generated to augment the subtractively altered light from one or more of the same or from a different selected region of the scene. The additional image content may relate only to the one or more selected regions or only to another selected region or it may relate to a user's view of the whole scene.

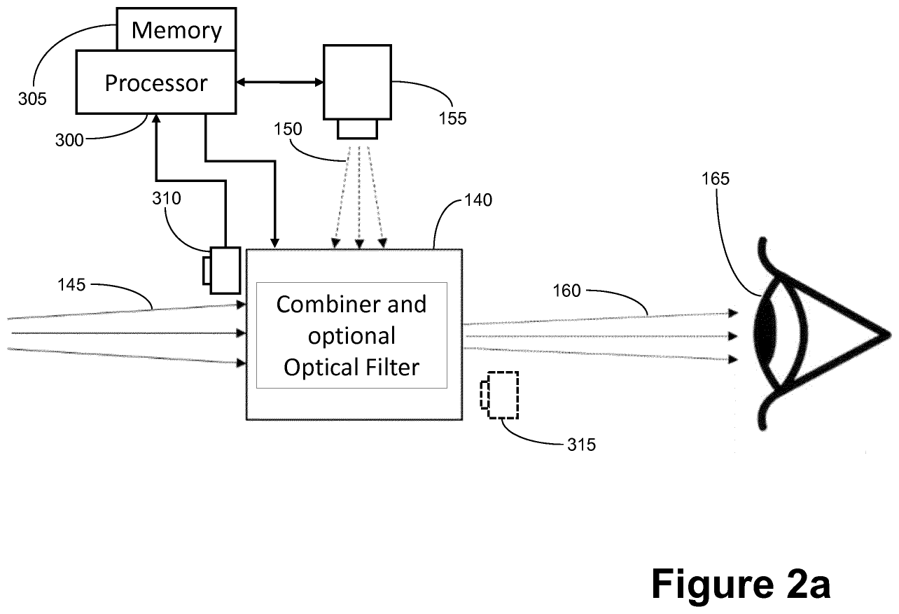

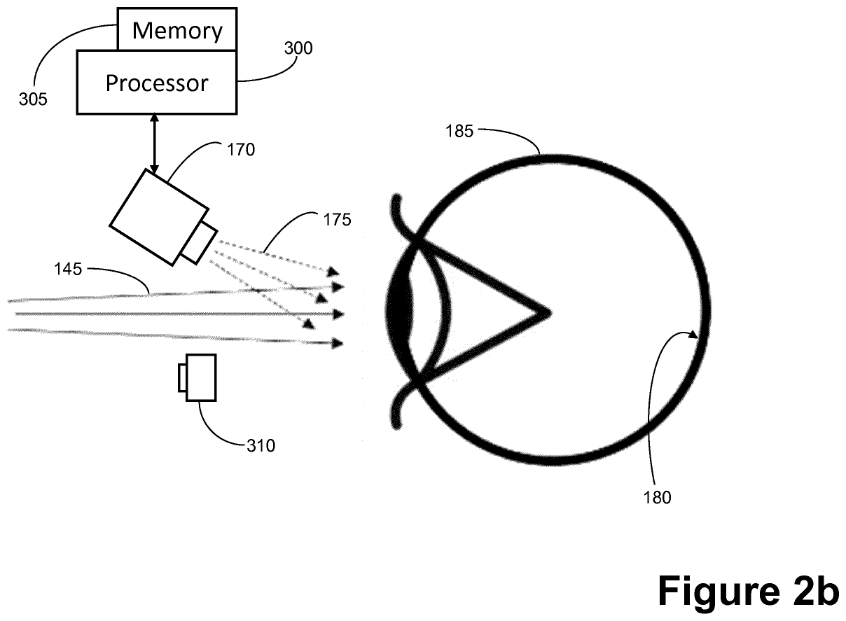

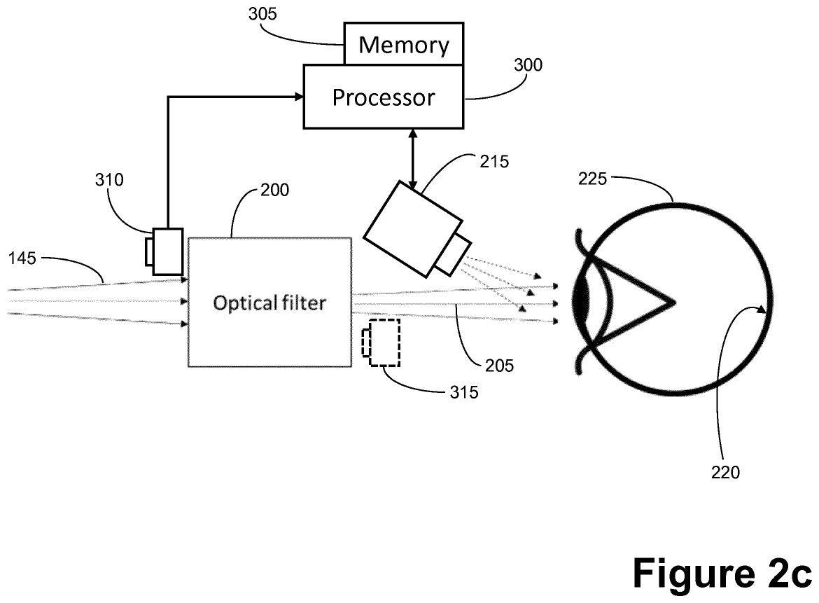

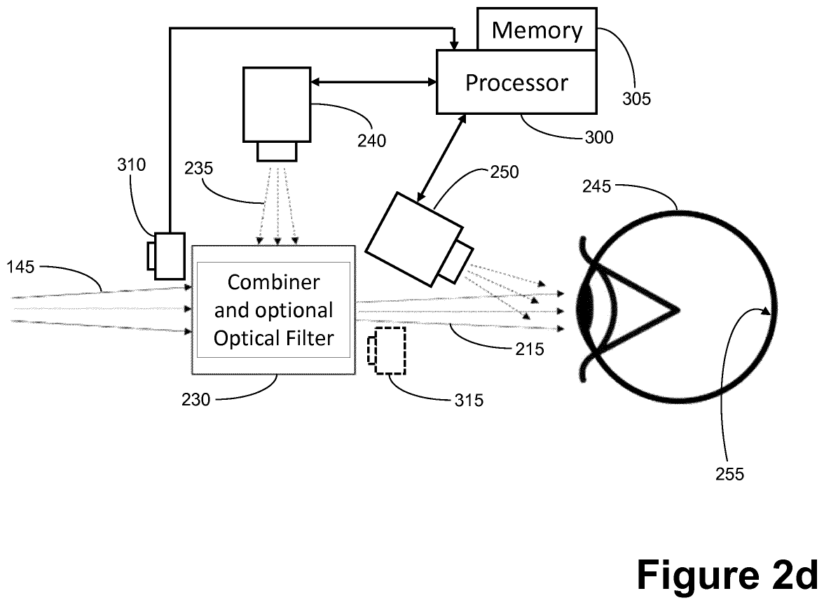

Before proceeding further with detail of example embodiments for achieving a perceived alteration to light in a see-through display, components of an example see-through display that may be used to achieve alterations to a user's perception of a real-world scene will now be described with reference to FIG. 2.

Referring to FIG. 2a, in an example embodiment of a see-through display according to the present disclosure, there is provided (140) a combiner and an optional optical filter positioned to receive light 145 from a real-world scene. The combiner is configured to receive light 150 projected from an image generator and projector 155, carrying additional image content, and to direct that light towards the user. The optional optical filter may be configured to alter the light 145 received from the real-world scene according to the filtering characteristics of the optical filter. The combiner is configured to pass or to re-direct the light that is passed by the optical filter and to combine it with the light 150 received from the image generator and projector 155 such that the combined light 160 is directed towards the eye 165 of a user. In this way, the user perceives the additional image content overlaying the optically-filtered view of the scene. The optical filtering and combiner features may be implemented by a single transparent optical component.

In an alternative implementation of the display in FIG. 2a, the optical filter may be positioned to receive light from the combiner, that is, to receive the light 145 from the real-world scene combined with the light 150 carrying the additional image content. In this way, the optical filter may apply the configured filtering characteristics not only to the light 145 received from the real-world scene, but also to the light 150 carrying the additional image content. The additional image content may therefore be generated to take account of the application of such optical filtering in creating intended alterations to the user's view of the real-world scene.

In a further alternative implementation of the display in FIG. 2a, the optical filter may comprise one or more filtering components placed on both sides of the combiner. That is, one or more first filtering components may be placed to receive the light 145 from the real-world scene directly. One or more second filtering components may be placed to receive light from the combiner, comprising light passed by the one or more first filtering components combined with the light 150 carrying the additional image content.

The optical filter may comprise one or a combination of known types of optical filter.

For example, the optical filter may be configured to alter the luminance of received light. Alternatively, or in addition, the optical filter may be configured to pass received light 145 in only one or more ranges of wavelength. Alternatively, or in addition, the optical filter may be configured to pass received light according to the angle of polarisation of the received light. Alternatively, or in addition, the optical filter may be configured to apply optical filtering on one or some areas of the scene based on information extracted from the scene. This information might be updated dynamically with e.g. changes in the scene, or the movement of the display or the viewer relative to the scene or relative to each other, or a change in the line of sight of the user. Alternatively, or in addition, the optical filter may be configured to alter the characteristics of light as it passes through the filter in other ways, for example to change the angle of polarisation of the received light. The light passed by the optical filter then passes through the combiner or is redirected by the combiner towards the eye of the user, with or without also passing through an additional optical filter as discussed above.

Alternatively, or in addition, the optical filter may include or be associated with an active blocking layer configurable to prevent, or to partially prevent light in one or more selected regions within the aperture of the display from reaching the optical filter. In this way, particular regions in the user's view of the scene may be blocked, or partially blocked, i.e. dimmed. This provides an opportunity to replace the user's view of that region of the scene with additional image content generated by the image generator 155 and displayed at an appropriate position in the display while the user continues to view light from the remainder of the scene.

In the display arrangement shown in FIG. 2a, the combiner (140) may for example be configured as for known AR applications of see-through displays, shown in any of the FIGS. 1a, 1b or 1c, described above.

Referring to FIG. 2b, in an example embodiment of a see-through display according to the present disclosure, there is provided an image generator and projector 170, attached for example to a head-mountable frame (not shown in FIG. 2a). The image projector 170 may be supported and orientated to project light 175 carrying additional image content onto the retina 180 of a user's eye 185. The additional image content may be generated so as to appear to overlay the user's view of the real-world scene and to make additive alterations to the user's perception of the light 145 arriving from a real-world scene in ways discussed above and to be discussed further below. In this case, the retina 180 is acting as a combiner in the display.

Not shown in FIG. 2b, the display may also incorporate an eye tracking arrangement to determine the direction gaze of the eye 185 or its line of sight to the scene. Information indicating a determined line of sight of the eye 185 may be used in generating additional image content to be projected by the projector 170, for example in any of the ways discussed above.

Referring to FIG. 2c, in an example embodiment of a see-through display according to the present disclosure, there is provided an optical filter 200 of a similar type and having similar features to that (140) discussed above with reference to FIG. 2a. The optical filter 200 is arranged selectively to pass some of the light 145 received from the real-world scene and to allow the filtered light 205 to progress towards the eye 225 of the user. There is also provided an image projector 215, positioned to project light carrying additional image content onto the retina 220 of the user's eye 225. The user is then able to see the light 145 arriving from a real-world scene, as passed by the optical filter 200, combined with the additional image content, appearing to overlay the user's view of filtered light from the real-world scene.

Referring to FIG. 2d, in an example embodiment of a see-through display according to the present disclosure, there is provided (230) a combiner and optional optical filter similar to, and having similar features to the combiner and optional optical filter 140 component described above with reference to FIG. 2a. The optional optical filter may be arranged to receive the light 145 from a real-world scene and to filter the received light 145 according to the filtering characteristics of the optical filter. The combiner is arranged to receive light 235 generated and projected by an image generator and projector 240, carrying additional image content. The combiner is configured to pass or to re-direct the light received from the real-world scene, optionally after filtering by the optical filter, and to combine it with the light 235 received from the image generator and projector 240 such that the combined light 215 is directed towards the eye 245 of a user. In this way, the user perceives the additional image content overlaying a view of the scene. However, a further image generator and projector 250 may be provided, similar to the image generator and projector 170 in FIGS. 2b and 215 in FIG. 2c. The image generator 250 is similarly arranged to project light carrying additional image content onto the retina 255 of the user's eye 245 such that the additional image content appears to overlay the user's view of light from the real-world scene. In this way, two opportunities are provided to combine additional image content with light passed by the optical filter to alter the user's perception of the real-world scene.

As discussed above with reference to FIG. 2a, the optical filter may comprise one or more optical filtering components placed relative to the combiner in any one of the example ways discussed above.

In each of the embodiments of a see-through display described above with reference to FIG. 2, any of the image generators 155, 170, 215, 240 and 250 may receive controlling signals or data from a processor 300, configured to define the additional image content to be generated and displayed in the display. The processor 300 may be a conventional digital processor configured to execute computer programs stored in an associated memory 305. Alternatively, or in addition, the processor 300 may comprise one or more known types of configurable logic device, for example a Field-Programmable Gate Array (FPGA), configured to implement functionality to define the additional image content and to perform other functions disclosed herein. In either implementation, the processor 300 may be configured to store data in the memory 305 or to access data stored in the memory 305.

Either or both of the processor 300 and the memory 305 may optionally be associated with the respective display, for example implemented as components of the display. Alternatively, or in addition, either or both of the processor 300 and the memory 305 may be separate from the respective display and be configured to communicate with the display over a communications link. The communications link may be a wireless communications link, for example a link established through a mobile communications network, or a short-range wireless link such as “wi-fi” (IEEE 802.11 wireless standard), Bluetooth® or an optical, e.g. infra-red (IR) communications link. Alternatively, the processor 300 may be configured to communicate with the display over a physical communications link. The physical communications link may be implemented, for example, using an optical fibre, or a communications link may be established over an electrical conductor or transmission line. A processor 300 and memory 305 may be provided as components of a single data processing facility, or they may be components of an edge computing or cloud-hosted data processing facility configured to communicate with components of the display. An edge-computing or cloud-hosted facility may for example be beneficial in a multi-user environment, as will be discussed further below.

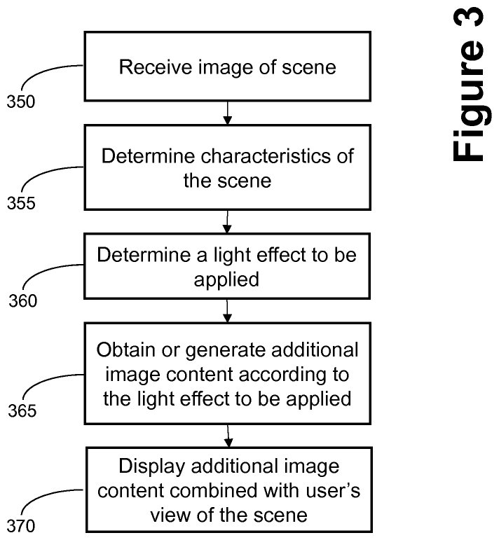

The memory 305 may for example store one or more computer programs which when executed by the processor 300 cause the display to operate a process as will now be described in summary with reference to FIG. 3.

Referring to FIG. 3, the process begins at 350 with receiving an image of a scene, for example as captured by an appropriately aligned digital camera associated with the display. At 355, the processor determines, for example by analysis of the received image, one or more characteristics of the scene. At 360, the processor determines a light effect to be applied to the user's view of the scene. At 365, the processor obtains or generates or causes to be generated additional image content according to the light effect determined at 360. At 370, the additional image content is displayed, combined with the user's view of light from the scene, thereby to apply the determined light effect to the user's view of the scene.

At 355, to determine a light effect to be applied, the processor may be configured to access the memory 305 which may be arranged to store profile data relating to different predetermined light effects that may be selected and generated in the display. The processor 300 may be configured to use the stored profile data to generate the additional image content, at 365, as required to simulate the determined light effect. The memory 305 may for example store user profile data indicative of a user's preferences for the creation of a specific light effect when viewing a scene through the display. The user profile data may reference one or more of the stored light effect profiles. The memory 305 may for example store information about a scene 25, for example a determined geometry of the scene. The processor 300 may be configured to may improve, complement or otherwise update this stored information through time. This informaton, for example the geometry of the scene, may be used for example for accelerating the processing of captured image data for a scene 25 at 355.

In an example embodiment, a processor 300, if implemented as a component of the display system, may be configured to receive, at 365, from a source external to the display system, data indicative of the additional image content to be generated. The received data may for example comprise an indication of a lighting profile to be implemented in the display, or the data may comprise image data defining the additional image content to be displayed.

The processor 300 may, for example, be configured to implement functionality to receive tracking information from tracking devices associated with the display system. The tracking system may be configured, for example in any of the display arrangements shown in

FIG. 2, to determine the position or orientation of the display system, the direction of gaze or line of sight of a user's eye through the display, or changes thereto. The processor 300 may be configured to use the received tracking information, at 365, to calculate the position at which additional image content is to be displayed within the image area of the display. The position calculated for display may for example be determined to space-stabilise the additional image content in the display relative to features visible to the user in the real-world scene. The processor 300 may be configured to use received tracking information relating to the user's line of sight to the scene 25 to make corresponding adjustments, at 365, to the content or quality of any additional image content to be displayed, in any of the ways discussed above.

The processor 300 may, for example, be configured to implement functionality for generating, at 365, the additional image content using a frame-based digital image-generating technique, for example at a frame rate of 50 or 60 Hz. Where additional image content is required to be space-stabilised relative to a user's view of the real-world scene, the processor 300 may be configured to re-calculate the position at which additional image content is displayed within the display for each new image frame. The processor 300 may also be configured to receive data defining changes in orientation of the display at the frame rate, or more frequently. The processor 300 may use the received change in orientation data to calculate, at 365, the position at which additional image content should be displayed in the display for each new image frame in order to maintain the perceived light effect.

The processor 300 may be configured to execute, at 355, a SLAM algorithm, referenced above, wherein determining characteristics of the scene comprises identifying and mapping features visible within the scene. In this way, information may be derived relating to the relative position of features visible within the scene. Features may be identified within the scene by the SLAM algorithm according to changes in luminance or colour of pixels, enabling structures within the scene to be determined. The determined structures may represent objects within the scene, boundaries of shadow or light, colour change boundaries, etc. The information may also be used to determine changes in the orientation of the display. The SLAM algorithm may use any changes in relative position of the identified features to determine changes in position and/or orientation of the display. The determined changes in orientation from the SLAM algorithm may be used by the processor 300 at 365, either instead of, or to supplement tracking data received from a tracking system when generating additional image content. The processor 300 may be configured to receive information from other sensors, e.g. cameras positioned to observe the scene 25, not necessarily located at the position of the camera 310, and so observe the scene 25 from one or more different directions.

Image data of the real-world scene may be received at 350 by the processor 300 from a camera mounted in a fixed position relative to the display to capture light as may be viewed by a user from the real-world scene. In any of the example display systems shown in FIG. 2, a camera 310 may be mounted in a fixed position relative to the display to receive light 145 from the real-world scene. The camera 310 may for example be a component of the display. Alternatively, the camera 310 may be mounted at a known position relative to the display to receive light from the real-world scene, capturing a similar view of the real-world scene as is available through the display. The camera 310 may be linked to supply image data for the scene 25 or other information to the processor 300.

The camera 310 may be configured to detect or output particular information about the scene 25. For example, the information may comprise light intensity or geometry of the scene. The camera 310 may for example be an RGB camera, a depth camera or a light-field camera.

Optionally, in an alternative arrangement or in addition to the camera 310, a camera 315 may be mounted in a fixed position to receive light passed or re-directed by the optical filter and combiner 140, 200, 230. Such an arrangement enables the processor 300, at 355, to analyse light of a real-world scene, before or after alteration in the respective display. The analysis may for example determine one or more of: the location or relative position of objects or features visible in the scene; material properties of those objects or features; the position of those objects or features relative to light sources or light obstructers; the viewing geometry; and actual illumination of the scene, including for example the variation of luminance or colour across the scene.

The processor 300 may, for example, be configured to implement functionality to receive, at 350, image data captured by one or both of the cameras 310, 315 and to determine, at 355, a light model of the scene. The light model may for example comprise one or more of the position, intensity or colour of light emitted by a light source. The resulting lighting model may then be used to determine what alterations are going to be required to the user's perception of the current lighting of the scene in order to apply a preferred light effect for the scene as it will appear to the user. The processor 300 may be configured to apply the preferred light effect by controlling the display to add one or more virtual light sources and light obstructers to the determined lighting model of the scene, calculating their effect on the lighting of the scene, and determining, at 365, any additional image content to be generated. The perceived lighting of the scene will then comprise one or more of: filtered light from the real-world scene; the light from the real-world scene combined with a view of the additional image content; and filtered light from the real-world scene combined with a view of the additional image content.

If an actively configurable optical blocking layer is provided in the display, for example one associated with the optical filter as discussed above, the processor 300 may also be configured to control the actively configurable blocking layer at least partially to block light from one or more selected regions of the scene. Corresponding additional image content may be generated at 365 and displayed at 370 at an appropriate position in the display, for example to replace the blocked or partially blocked light or otherwise to exploit the at least partial blocking of light to achieve a desired light effect in the user's perception of the scene. In one example embodiment, the light that is to be at least partially blocked by the blocking layer and the light that is to be filtered by the optical filter may be determined by functionality implemented by the processor. Furthermore, the processor 300 may be configured, for example as part of the processing at 365, or in a separate process, to determine a region within the aperture of the blocking layer that is to be activated at least partially to block light according to determined changes in orientation of the display. In this way, the region in the user's view of the scene from which light is to be at least partially blocked may remain unaltered by changes in orientation of the display when viewed through the display. The region may comprise the apparent (user's perception of the) position of an object or other feature identified within the scene. Any additional image content generated at 365 to correspond to that region of the scene may therefore relate to the object that would be visible through the display in that respective direction.

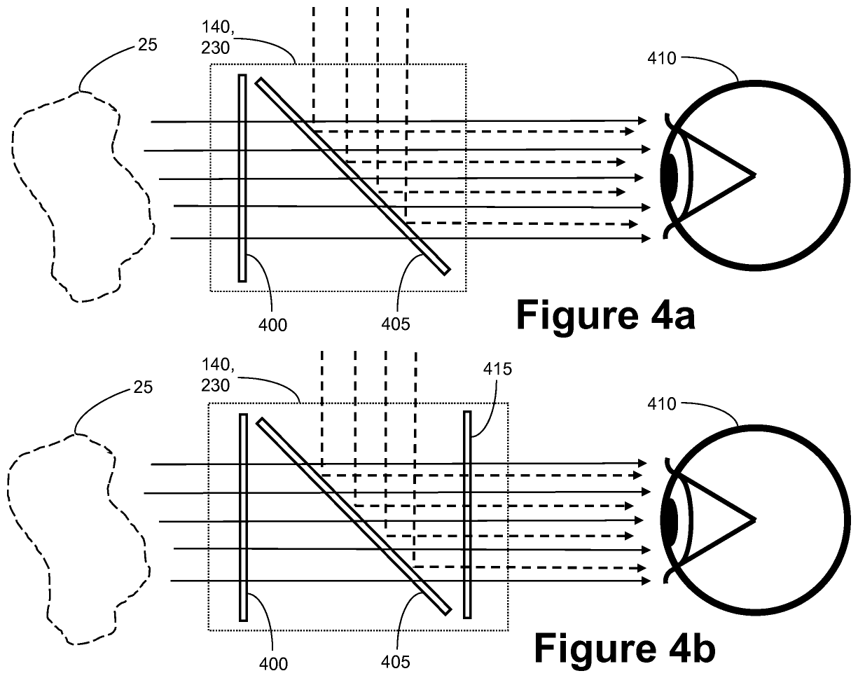

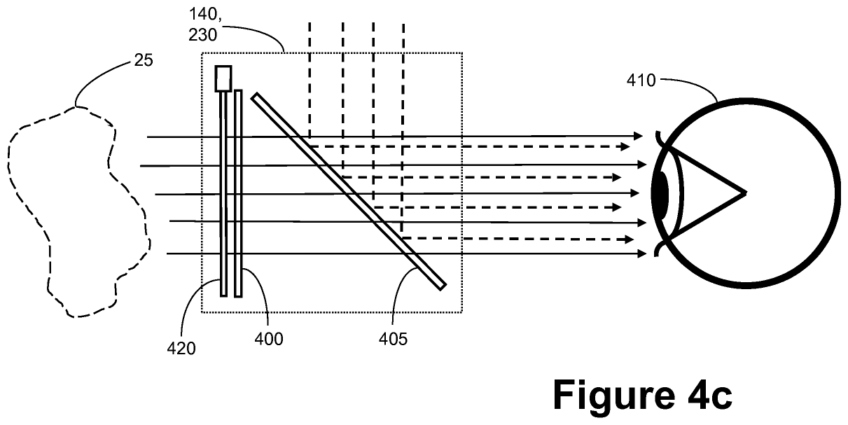

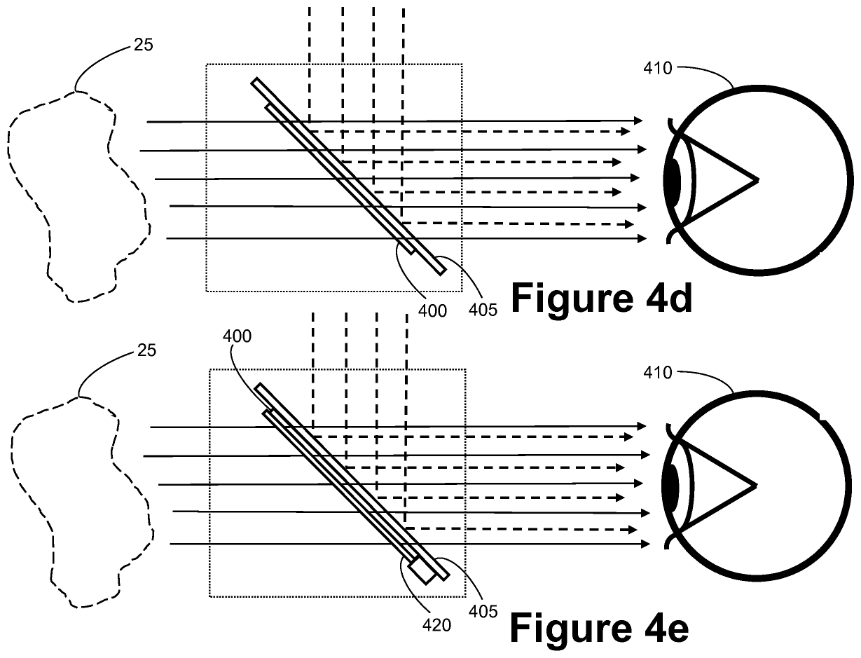

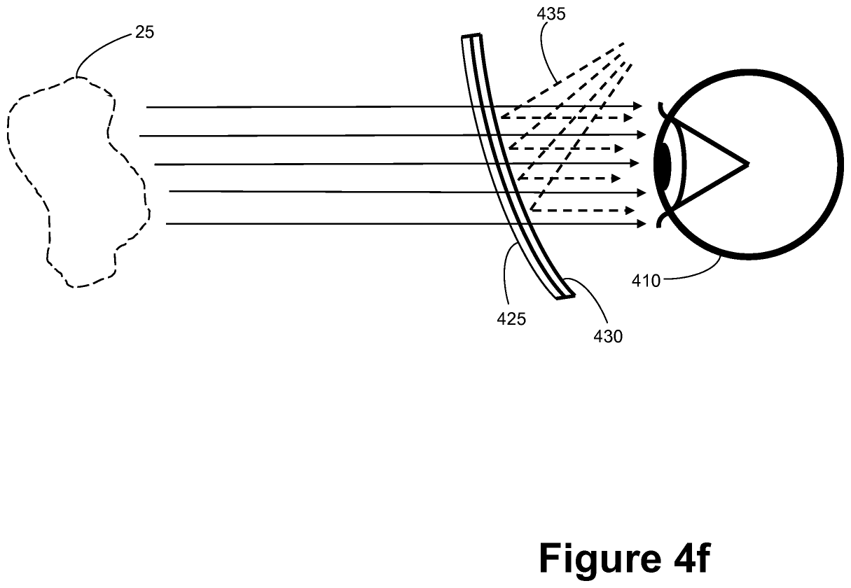

Some example embodiments will now be described with reference to FIG. 4 showing different ways in which the combiner and optional optical filter component 140, 230 may be implemented.

Referring to FIG. 4a, the combiner and optional optical filter component 140, 230 may comprise an optical filter component 400 and a separate transparent combiner component 405. The optical filter component 400, oriented in this example at substantially 90° to the direction of light being received from a real-world scene 25, is configured to filter the received light and to allow the filtered light to continue through the transparent combiner component 405 towards an eye 410 of a user.

Referring to FIG. 4b, the optical filter component 400 and the combiner component 405 may be positioned as in FIG. 4a. However, a second optical filter component 415 may be provided, oriented in this example at substantially 90° to the direction of light being received from the combiner component 405, to filter the combined light before passing the filtered light to the eye 410 of the user.

Referring to FIG. 4c, in an arrangement similar to that shown in FIG. 4a, an active blocking layer or configurable blocking filter 420 may be positioned to receive light from the real-world scene 25 and to block light from one or more selected regions within the aperture of the display. In FIG. 4c, the blocking layer 420 is positioned in parallel with the optical filter component 400 to receive the light from the scene before it reaches the optical filter component 400. However, in a variant, the blocking layer 420 may be positioned between the optical filter component 400 and the optical combiner component 405.

Referring to FIG. 4d, the optical filter component 400 is oriented to be substantially parallel to the optical combiner component 405.

Referring to FIG. 4e, both the optical filter component 400 and the blocking layer 420 are oriented to be substantially parallel to the optical combiner component 405.

Referring to FIG. 4f, in a head-mounted display for example, a curved optical filter component 425 may be arranged adjacent to a curved optical combiner component 430 in front of a user's eye 410. The optical combiner component 430 may be arranged to receive light 435 from an image generator/projector and to re-direct the light 435 towards the user's eye 410, in combination with the light passed by the optical filter component 425.

In each of the arrangements shown in FIG. 4, the filtering characteristics of the separate optical filter component 400, 425 may be incorporated into the optical combiner component 405, 430 so that those two separate components may be implemented as a single optical filter/combiner component.

Similarly, in a variant of either of the arrangements shown in FIG. 4c and FIG. 4e, the functions of the optical filter component 400 and the blocking layer 420 may be implemented in a single optical component. Alternatively, in a variant of the arrangement shown in FIG. 4e, the functions of the optical filter component 400, the blocking layer 420 and the optical combiner 405 may be implemented in a single optical component. Other structures and arrangements implementing one or more filters and combiners as would be apparent to a person of ordinary skill may alternatively be used, according to the particular application and type of display being implemented.

Some example embodiments of light effects that may be implemented using, for example, the embodiments of a display described above with reference to FIG. 2, will now be described. These example embodiments define different ways in which a see-through display according to embodiments of the present invention may be configured and used to create an altered perception of a scene being viewed through the display. Where appropriate, components shown in FIG. 2 will be referenced to indicate example ways in which those components may be configured to create the intended effects.

An example embodiment enables a user to perceive adjustable scene lighting when viewing a scene through the display. The adjustable scene lighting may be generated by overlaying additional image content simulating the effect of one or more virtual light sources or obstructers on top of the user's actual view of the scene. Such an effect may be implemented by the see-through display described above with reference to any of FIGS. 2a to 2d. In each implementation, at least a part of the light providing a view of the scene for the user is coming from the natural scene, while any virtual light sources are being simulated in additional image content generated by any of the image generators and projectors 155, 170, 215, 240 and 250 under the control of a processor 300. Virtual light obstructers may be simulated in the display of FIGS. 2a, 2c and 2d by reducing the luminance of the light 145 from the scene by an optical filter 140, 200 and 230. Alternatively, if provided as a component in the display, one or more active blocking layers may be controlled at least partially to block light received from one or more selected regions of the scene before it reaches the optical filter. The one or more active blocking layers may be placed at least partially to block light before reaching the optical filter, or after passing through the optical filter, or both. If more than one active blocking layer is provided, each blocking layer may be configured at least partially to block light from a different selected region in the aperture of the display. Blocked or at least partially blocked light may, if required, be replaced or supplemented in the user's view of the scene by additional image content displayed in the same position as a region subject to blocking or partial blocking, or in a related position within the user's view of the scene.

Virtual light sources and obstructers may be simulated to be far from the scene being viewed by the user, e.g. a virtual sun or virtual cloud. Alternatively, the virtual light sources may be close to or within the user's view of the scene, e.g. a virtual extra lamp in a room. Virtual light sources and obstructers may therefore be visible within the user's field of view of the scene, or they may themselves be outside the user's field of view, but with effects that are visible within the user's field of view. Light obstructers may act as a virtual object in the scene (inside or outside the field of view) and may affect the lighting of the scene, e.g. by their shadow, visible within the user's field of view.

Examples of virtual light effects that may be superimposed with additional image content in an AR scenario may include:
Sunny sky with sunrays from the sun. The rays will give the impression that the virtual sun is shining bright.
Sunset or sunrise with gradual darkening/reddening of the sky. By analysing image data of the scene, the processor may be configured to detect and locate the sky in a user's view of a real-world scene. The user's view of the sky may then be altered by a combination of optical filtering and additional image content to create, for example, a gradual darkening/reddening effect around a virtual sun that sets/rises at a horizon. The remainder of the scene may be darkened/reddened accordingly.
Cloudy sky with rain. Clouds may be superimposed upon the user's view of a real-world sky and the sky may be slightly darkened. Virtual drops of rain may be represented in additional image content so as to appear to fall from the sky. A rainbow may also be superimposed.
Moonlight by day. By darkening the real-world scene and filtering out colours to give a more monochrome effect, the user's view of the scene may be one of moonlight during the day. A full moon may also be superimposed in the sky.
Virtual lightning. This may be simulated in additional image content, for example by including an image of a lightning bolt in one or two image frames of additional image content. The additional image content displayed during those image frames may comprise a brighter representation of the whole scene, generated using, for example, image data captured by a camera with a view of the scene. A virtual lightning event may be accompanied by generating the sound of a lightning strike or of a subsequent rumble of thunder, according to how close to the user's view of the scene the lightning strike is intended to have occurred.
‘Devilish’ sky with red and black clouds sweeping in.
Unnatural light effects such as greenish light from the sky.
Dim regions made lighter. Additional image content may be generated to cause a user's view of dim areas within the scene to appear brighter, for example to enhance visibility in low-light areas. One example may comprise generating additional image content corresponding to a lighter representation of an area of shadow in a football stadium (e.g. when half the field is in shadow) and displaying it in a space-stabilised position relative to the user's view of the stadium such that the user's eye does not need to adapt between dark and bright areas.
Highlighting an object visible within a scene. For example, to provide individual illumination of the object, e.g. illumination from a light source associated with the object so that the light source moves with the object, or a theatre spot-light or similar illumination effect in which the light source is fixed and follows the object if it moves within the scene. The purpose of the individual illumination may for example be to highlight the object to the user, to provide a warning (e.g. illumination with red light) in respect of the object, or for tracking purposes, enabling the user more easily to track movement of the object through the scene.
Re-colouring of an object, for example to appear to the user to be red instead of green.

The virtual scene light effects may be controlled manually by the user, e.g. via a graphical user interface or by voice control. Alternatively, the effects may be controlled according to input from sensors (e.g. light detectors, etc.) or by other external means. For example, one of a number of predetermined light effects may be triggered by a predefined sequence of events by the user. For example, the selection of a particular scene light effect may be triggered by an audible input. For example, different light effects may be selected depending on determined characteristics in detected sounds, for example a determined ‘mood’ of music that is being played by a user while viewing a scene through a display as disclosed herein. Alternatively, or in addition, a predetermined light effect may be selected according to the occurrence of one or more such events, as defined in a user profile for the user, as discussed above.

In an example embodiment, one or more predetermined lighting settings or lighting profiles may be defined and stored for selection as required. Each lighting setting or profile may define one or more virtual light sources and/or light obstructers to be implemented in a display, with a defined set of parameters. The defined parameters may include, but not be limited to defining a luminance profile across one or more regions or across the whole of a viewing aperture in a display. A luminance profile, for example, may be implemented in the display by one or both of filtering light received from a scene by an optical filter, and generating additional image content. The additional image content may be generated based upon received image data captured by a camera of one or more regions in the user's view of a scene.

Further parameters may define conditions under which the defined lighting setting or light effect profile is to be implemented in a display. For example, a given lighting setting or light effect profile may be triggered when a scene being viewed is determined as being an indoor scene or when an outdoor scene. Alternatively, or in addition, a given lighting setting or light effect profile may be triggered at particular times or during defined time intervals. For example, a given lighting setting or light effect profile may be applied in a display during a defined morning period or during a defined evening period. Alternatively, or in addition, a given lighting setting or light effect profile may be triggered when a pre-defined characteristic of the scene, for example an object, gesture or event is detected or recognised in the field of view of the display. One or multiple conditions may be defined for triggering a lighting setting or light effect profile. The lighting setting or light effect profile to be applied may be chosen or scheduled by a user or a real-world source and may be triggered for example by one or more of:

detection of a predetermined characteristic of the scene;

detection of an input by a user in a user interface;

detection of an audible input;

determination of a predetermined characteristic in a detected audible input;

detection of a gesture by the user;

determination of the presence of a predetermined object or other feature in the received image data;

a predetermined time; and

a predetermined position or orientation of the display.

A processor 300 for use with a display disclosed herein may be configured to receive external or local sensor information, for example time, calendar information, GPS coordinates or orientation. The processor 300 may be configured to use these data to adjust the perceived position of a light source defined in a lighting profile. In one example, a combination of received GPS data, orientation and calendar information may be used to apply a virtual sunlight effect to a user's view of an indoor or outdoor scene, or to add the effect of the virtual sunlight to the user's view of a scene on a cloudy day.

In an example embodiment, several users may be using see-through displays according to embodiments discussed above, in the same environment. For example, several users may be located to view the same real-world scene from slightly different positions. In one example scenario, each of the users may agree upon a common lighting profile to be applied by their respective displays to alter each user's perception of the environment in substantially the same way. In this example scenario the processing required to control each of the displays may be shared. For example, an edge computing arrangement or cloud resources accessible to all the users may be configured to exploit redundancy. The redundancy may arise across the multiple views of the environment captured from each user's display in which the same features or different subsets of a common set of features in a scene may be visible to each user. The processing required to analyse images captured of a scene by multiple users may thereby be reduced. For example, a SLAM algorithm may be executed to determine a set of features visible to one or more users within a group. It may not be necessary to analyse images captured for all the users in the group if the same or a subset of the determined features are visible to all the users. There may also be possible to economise on the processing required to generate additional image content for a selected light effect to be applied in each user's display. The resulting lighting profiles, represented by additional image content appropriately adjusted according to each user's view position and view direction, or control signals for other display components such as a blocking layer as discussed above, may be streamed to each user's display from a common processing resource.

In an example variant of this embodiment, the light effects to be applied may be determined by a common authority, for example by a light and illumination control centre. All users having display connected to that centre, or subject to that common authority, may receive data or control signals to generate view-port-dependent altered lighting of the scene from edge nodes or cloud servers.

The altered light effects to be applied in the display of each user may be updated substantially in real time and streamed from an edge node or cloud server. For example, an edge node or cloud server may be configured to receive data indicative of a change in position and/or orientation of the display of any one user and to use those data in generating the altered light effect for that user. Updates may be generated and communicated to the respective display for example for each new image frame of a frame-based image generator.

In an example embodiment, in a multi-user arrangement, a common processing environment, for example the edge computing or cloud server arrangement mentioned above, may be configured to perform any analysis for a shared scene. That is, scene modelling for a scene viewable by different users may be performed using edge processors or cloud servers to reduce the demand for processing power on each device. For example, overlapping portions in views of a real-world scene captured from different displays may enable a reduction in the processing resources required to analyse the scene for any one user. The personalised lighting or ambiance effect for each user may be generated using the results of this common analysis to achieve the applied lighting profile for each user's view of the real-world scene.

In an example variant of this embodiment, the modelling of the scene may be performed progressively as the view point and/or view port of one or more users changes. Such modelling may include or be performed in a similar way to a 3D reconstruction of the scene by combining the information from one or a number of moving cameras.

In an example embodiment, ‘pick-and-place’ functionality may be implemented to implement a selected light effect. ‘Pick-and-place’ functionality may for example enable a user to select a light source or illumination effect, e.g. from one or more pre-defined light sources or illumination effects and, as appropriate, to place or otherwise specify a location of the selected light source or illumination effect within the user's view of the scene. Such functionality may be presented to a user or used in a similar way to an artist selecting paints from a colour pallet, enabling a user to design a desired light effect in a light-augmenting AR system.

Parameters that distinguish the different light sources or illumination effects, in one example light effect, may for example include one or more of a colour spectrum of the light source or illumination effect, its intensity, its position and its spread profile. In one example light effect, a tray for different types of light source or illumination effect may be prepared, from which the user may choose one or a number of light sources or illumination effects. The user may define controlling parameters and adjust the desired parameters for each light source or illumination effect. The user may place each light source or illumination effect at a desired position relative to the scene and modify the light source position or properties based on the observed effect. One exemplary use case of this embodiment may be fast prototyping of a lighting setup for professional use.

In an example embodiment, at least one virtual light source or virtual light obstructer may be defined and implemented in a display to have dynamic characteristics. That is, at least one of the parameters defining the light source or light obstructer may change over time or in response to new events. The parameters associated with a light source or light obstructer, having dynamic characteristics, may for example include one or more of the colour spectrum, intensity, position and spread profile of the light source. Dynamic lighting in this embodiment may for example be used for overlaying, e.g. dancing light or glitter effect to a user's view of a scene, or illumination of a moving object within the scene.

In an example embodiment, a lighting profile may be applied to different parts of a field of view of a display with different levels of detail. The result may be a different light augmenting quality in different parts of the field of view. Region-wise quality of the light-augmenting may for instance be based on a region of interest: high-quality light-augmenting within a region of interest; and low-quality light-augmenting for parts of the field of view outside the region of interest. One example of low-quality light augmenting may be to ignore the 3D structure of the scene and apply constant (uniform or with a fixed profile) light attenuation or enrichment to a part of the scene regardless of the content in that part. Attenuating (filtering out) light using optical filters is one example. Such techniques for applying different levels of quality have the benefit that a lower overall level of processing is required to implement the augmented lighting in the display.

In an example variant of this embodiment, an eye tracking system may be implemented in the display system to determine the gaze direction and/or focus of a user. Data from the eye tracking system may be used to ensure that the augmented lighting is applied in high quality (e.g. with high resolution) to a part of the field of view which is in the determined direction of the gaze and the remainder of the field of view is processed with a lower quality (e.g. lower resolution, ignoring the scene geometry).

In an example embodiment, the optical filter may be configured to filter one or more colours from a region of a scene and a re-colouring layer may be generated and displayed overlaying the region of the scene as additional image content. The user may then perceive the region of the scene in a different colour, according to the user's perception of the resultant combination of filtered light from the scene and the re-colouring light in the additional image content. The re-colouring effect may be designed to be realistic or non-realistic. The re-colouring effect to be applied may be defined in a user's profile indicating a preference for such a light effect. One reason for applying such a re-colouring may be to help to overcome a visual deficiency of the user, for example a “colour-blindness” difficulty which may, for example, reduce the user's ability to distinguish between green and red-coloured objects. A re-colouring of green or of red objects in a scene may enable the user to recognise a difference in colour of the objects.

In an example embodiment, a user's experience in viewing a scene, augmented by any of the ways discussed above, may be further enhanced with one or a combination of other sensory inputs. The other sensory inputs may include one or more of audio content and tactile stimuli, provided by transducers associated with the display, or provided by separate systems.

Example embodiments described above have included a method for operating a see-through display, the display being configurable to display additional image content for augmenting a user's view of a scene visible through the display, the method comprising:

receiving image data defining an image of a scene visible through the display;

determining, by analysis of the received image data, one or more characteristics of the scene;

determining a light effect to be applied to the user's view of the scene;

generating additional image content according to the determined light effect and according to the one or more determined characteristics of the scene; and

displaying the additional image content to the user such that light received from the scene is combined with the additional image content, thereby to implement the determined light effect in the user's view of the scene.

According to the method, determining the one or more characteristics of the scene may comprise determining at least one of:

characteristics of an object visible in the scene;

the position of an object visible in the scene;

a profile of luminance across a region in the scene;

a profile of colour across a region in the scene;

a light model of the scene; and

a time of capture of the image data.

According to the method, determining the one or more characteristics of the scene may comprise at least one of constructing, obtaining and updating a map of the scene.

According to the method, determining the one or more characteristics of the scene may comprise executing a SLAM method to analyse the received image data.

The method may comprise generating the additional image content comprising light with a different profile of luminance to that of light received from a respective region in the scene.

The method may comprise generating the additional image content comprising light with a different profile of colour to that of light received from a respective region in the scene.

The method may comprise filtering light received from a region of the scene using an optical filter and combining the light passed by the optical filter with the additional image content, thereby to implement the determined light effect in the user's view of the scene.

The method may comprise generating the additional image content to take account of characteristics of the light passed by the optical filter. Optionally, the determined light effect comprises changing the colour of light received from a region in the scene having a first colour such that the user sees light of a second, different colour from the region in the scene.

According to the method, the determined light effect may comprise changing the luminance of light received from a region in the scene having a first level of luminance such that the user sees light of a second, different level of luminance from the region in the scene.

The method may comprise generating the additional image content comprising a time varying profile of light across a respective region in the scene.

The method may comprise:

receiving data indicative of a change in orientation of the display; and

using the received orientation change data to determine a position in an image area of the display for displaying the additional image content such that the additional image content appears to the user to remain aligned with a respective region in scene after the indicated change in orientation of the display.

According to the method, determining a light effect to be applied to the user's view of the scene may comprise receiving user profile data defining the light effect to be applied.

Optionally, according to the method, the user profile data may define at least one event or condition for activating a respective light effect in the display, and the method may comprise:

responsive to determining that the at least one event or condition has occurred, generating and displaying additional image content to apply the determined light effect.

Optionally, the at least one event or condition comprises determining, by the analysis of the received image data, a presence of one or more predetermined characteristics of the scene.

The method may comprise controlling an active blocking layer to block or at least partially to block light received at the display from a selected region of the scene.

Optionally, the method comprises receiving data indicative of a change in orientation of the display; and

using the received orientation change data to control the blocking layer thereby to continue to block or at least partially to block the light received from the selected region of the scene following the indicated change in orientation of the display.

Optionally, the method comprises using the received data indicative of a change in orientation of the display as an indication of a change in the user's line of sight to the scene.

Optionally, the user's line of sight to the scene is assumed to be aligned with the centre of an image area of the display.

The method may comprise:

receiving data indicative of a line of sight of a user's eye through the display; and using the data to implement the light effect to take account of the line of sight of the user's eye through the display.

The method may comprise:

generating additional image content having a first level of image quality for display in a region of an image area of the display corresponding to the user's line of sight and generating additional image content having a second, lower level of image quality for display in other regions of the image area of the display.

Optionally, the additional image content having the first level of image quality comprises image content having a higher resolution than the additional image content generated having the second, lower level of image quality.

Optionally, the additional image content having the first level of image quality comprises image content having a higher level of colour resolution than that of additional image content generated having the second, lower level of image quality.

The method may comprise:

determining the user's line of sight through the display and determining a region in the image area of the display that corresponds to the user's determined line of sight through the display.

According to the method, the region in the scene may correspond to a determined object or other feature in the scene.

Example embodiments described above have included a see-through display, comprising:

an image generator configured to generate additional image content and to project the generated additional image content along a user's line of sight to a scene visible through the display such that light received from the scene is combined with the additional image content in the user's view of the scene;

a processor, linked to the image generator and configured:
to receive image data representing an image of a scene visible through the display;
to determine, by analysis of the received image data, one or more characteristics of the scene;
to determine a light effect to be applied to the user's view of the scene; and
to control the image generator to generate and to project additional image content according to the determined light effect and according to the one or more determined characteristics of the scene.

The see-through display may comprise an optical filter positioned to receive light from the scene and to pass received light, according to filtering characteristics of the optical filter, for viewing by the user.

The see-through display may comprise a camera positioned to capture images of a scene visible to the user through the display and to output to the processor corresponding image data.

The see-through display may comprise a camera positioned to capture images of a scene visible to the user through the optical filter and to output to the processor corresponding image data.

The see-through display may comprise a memory, accessible by the processor, configurable to store light effect profile data defining one or more predetermined light effects that may be applied in the display. Optionally, the memory is configurable to store user profile data defining one or more light effects to be applied in the display for the user. Optionally, the light effect profile data defines, for a said light effect, data defining at least one event or condition for triggering selection or application of the said light effect in the display. Optionally, the user profile data comprise data defining at least one event or condition for triggering selection or application of a defined light effect in the display.

Optionally, the at least one event or condition includes at least one of:

detection of a predetermined characteristic of the scene;

detection of an input by a user in a user interface;

detection of an audible input;

determination of a predetermined characteristic in a detected audible input;

detection of a gesture by the user;

determination of the presence of a predetermined object or other feature in the received image data;

a predetermined time; and

a predetermined position or orientation of the display.

Optionally, the see-through display comprises a blocking layer configurable at least partially to block light from a selected region in a user's view of the scene, wherein the processor is configured to control the configurable blocking layer according to the determined light effect and according to the one or more determined characteristics of the scene.

The see-through display may comprise one or more components of a tracker system arranged to determine changes in orientation of the display and to output, to the processor, orientation data indicative of a change in orientation of the display, the processor being configured to receive the orientation data and to use the received orientation data to generate the additional image content.

The see-through display may comprise a blocking layer configurable at least partially to block light from a selected region in a user's view of the scene, the processor being configured to control the configurable blocking layer according to the received orientation data.

The see-through display may comprise a head-up or head-mounted see-through display.

Example embodiments described above have included a computer program which when loaded into and executed by a processor of a see-through display, cause the processor:
to receive image data representing an image of a scene visible through the display;
to determine, by analysis of the received image data, one or more characteristics of the scene;
to determine a light effect to be applied to a user's view of the scene through the display; and
to control an image generator of the display to generate and to project additional image content according to the determined light effect and according to the one or more determined characteristics of the scene.

Optionally, the computer program, when loaded into and executed by the processor of a see-through display, causes the processor to implement the method according to any one of the embodiments of the method described herein.

Example embodiments described above have included a computer program product, comprising a computer-readable medium, or access thereto, the computer-readable medium having stored thereon the computer program defined above.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium. Alternatively, or in addition, it may, for example, be in the form of a signal such as a downloadable data signal provided from a website accessible over the Internet, or it may take any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim; “a” or “an” does not exclude a plurality; and a single processor or other unit may fulfil the functions of several units recited in the claims. Any reference signs in the claims shall not be construed so as to limit their scope.

1. A method for operating a see-through display, the display being configurable to display additional image content for augmenting a user's view of a scene visible through the display, the method comprising:
receiving image data defining an image of a scene visible through the display;
determining, by analysis of the received image data, one or more characteristics of the scene;
determining a light effect to be applied to the user's view of the scene;
generating additional image content according to the determined light effect and according to the one or more determined characteristics of the scene; and
displaying the additional image content to the user such that light received from the scene is combined with the additional image content, thereby to implement the determined light effect in the user's view of the scene.

2. The method according to claim 1, wherein determining the one or more characteristics of the scene comprises determining at least one of:
characteristics of an object visible in the scene;
the position of an object visible in the scene;
a profile of luminance across a region in the scene;
a profile of colour across a region in the scene;
a light model of the scene; and
a time of capture of the image data.

3. The method according to claim 1 or claim 2, wherein determining the one or more characteristics of the scene comprises at least one of:
constructing, obtaining and updating a map of the scene; and
executing a SLAM method to analyse the receive image data.

4. (canceled)

5. The method according to claim 1, comprising:
generating the additional image content comprising light with a different profile of luminance or a different profile of color to that of light received from a respective region in the scene.

6. (canceled)

7. The method according to claim 1, comprising:
filtering light received from a region of the scene using an optical filter and combining the light passed by the optical filter with the additional image content, thereby to implement the determined light effect in the user's view of the scene.

8. The method according to claim 7, comprising:
generating the additional image content to take account of characteristics of the light passed by the optical filter.

9-10. (anceled)

11. The method according to claim 1, comprising:
generating the additional image content comprising a time varying profile of light across a respective region in the scene.

12. (canceled)

13. The method according to claim 1,
wherein determining a light effect to be applied to the user's view of the scene comprises receiving user profile data defining the light effect to be applied.

14. The method according to claim 13, wherein the user profile data defines at least one event or condition for activating a respective light effect in the display, and the method comprises:
responsive to determining that the at least one event or condition has occurred, generating and displaying additional image content to apply the determined light effect.

15. The method according to claim 14, wherein the at least one event or condition comprises determining, by the analysis of the received image data, a presence of one or more predetermined characteristics of the scene.

16. The method according to claim 1, comprising:
controlling an active blocking layer to block or at least partially to block light received at the display from a selected region of the scene.

17-20. (canceled)

21. The method according to claim 1, comprising:
generating additional image content having a first level of image quality for display in a region of an image area of the display corresponding to the user's line of sight and generating additional image content having a second, lower level of image quality for display in other regions of the image area of the display.

22. The method according to claim 21, wherein the additional image content having the first level of image quality comprises image content having a higher level of image or colour resolution than the additional image content generated having the second, lower level of image quality.

23-25. (canceled)

26. A see-through display, comprising:
an image generator configured to generate additional image content and to project the generated additional image content along a user's line of sight to a scene visible through the display such that light received from the scene is combined with the additional image content in the user's view of the scene;
a processor, linked to the image generator and configured:
to receive image data representing an image of a scene visible through the display;
to determine, by analysis of the received image data, one or more characteristics of the scene;
to determine a light effect to be applied to the user's view of the scene; and
to control the image generator to generate and to project additional image content according to the determined light effect and according to the one or more determined characteristics of the scene.

27. The see-through display according to claim 26, comprising an optical filter positioned to receive light from the scene and to pass received light, according to filtering characteristics of the optical filter, for viewing by the user.

28. The see-through display according to claim 26, comprising:
a camera positioned to capture images of a scene visible to the user through one or both of the display and the optical filter and to output to the processor corresponding image data.

29. (canceled)

30. The see-through display according to claim 26, comprising:
a memory, accessible by the processor, configurable to store light effect profile data defining one or more predetermined light effects that may be applied in the display.

31. The see-through display according to claim 30, wherein the memory is configurable to store user profile data defining one or more light effects to be applied in the display for the user.

32. The see-through display according to claim 30, wherein the light effect profile data or the user profile data defines, for a said light effect, data defining at least one event or condition for triggering selection or application of the said light effect in the display.

33. (canceled)

34. The see-through display according to claim 32, wherein
the at least one event or condition includes at least one of:
detection of a predetermined characteristic of the scene;
detection of an input by a user in a user interface;
detection of an audible input;
determination of a predetermined characteristic in a detected audible input;
detection of a gesture by the user;
determination of the presence of a predetermined object or other feature in the received image data;
a predetermined time; and
a predetermined position or orientation of the display.

35. The see-through display according to claim 26, comprising: a blocking layer configurable at least partially to block light from a selected region in a user's view of the scene, wherein the processor is configured to control the configurable blocking layer according to the determined light effect and according to the one or more determined characteristics of the scene.

36-40. (canceled)

41. A computer program product, comprising a computer-readable medium, or access thereto, the computer-readable medium having stored thereon a computer which when loaded into and executed by a processor of a see-through display, causes the processor:
to receive image data representing an image of a scene visible through the display;
to determine, by analysis of the received image data, one or more characteristics of the scene;
to determine a light effect to be applied to a user's view of the scene through the display; and
to control an image generator of the display to generate and to project additional image content according to the determined light effect and according to the one or more determined characteristics of the scene.
